(19) United States
(12) Patent Application Publication
(10) Pub. No.: US 2021/0264324 A1
(43) Pub. Date: Aug. 26, 2021

(54) LOW HOSTING ACTIVITY-TRIGGERED HOST RECOMMENDATION TOOL

(71) Applicant: Airbnb, Inc., San Francisco, CA (US)

(72) Inventors: Rajnish Kumar, San Francisco, CA (US); Joao Pedro Carvalho Oliveira de Miranda Reis, San Francisco, CA (US); Laetitia Kim Anh Perrine Jumel, New York, NY (US); Dan Young Li, San Francisco, CA (US); Zhiyao Wang, San Francisco, CA (US)

(21) Appl. No.: 16/796,810

(22) Filed: Feb. 20, 2020

(51) Int. Cl. G06Q 10/02; G06F 16/29; G06F 16/245; G06N 20/00

(52) U.S. Cl. CPC G06Q 10/02; G06N 20/00; G06F 16/245; G06F 16/29

(57) ABSTRACT

A system and a method are disclosed for matching users of an accommodation management system to an event and prompting the matched users to make an accommodation listing available during the event. In an embodiment, the accommodation management system detects an event occurring in a geographic region. Responsive to detecting the event, the accommodation management system identifies users registered in the geographic region that are exhibiting low hosting activity. The accommodation management system compares the event to accommodation listings on a wish list associated with each retrieved user. Responsive to a successful match between the event and a retrieved user's wish list, the accommodation management system outputs a prompt to the user recommending that the user make a listing for an accommodation available during the event.

### CROSS REFERENCE TO RELATED APPLICATIONS

This application is related to U.S. application Ser. No.: ______ (Atty Docket No.: 26887-45138/US), entitled “EVENT-TRIGGERED HOST RECOMMENDATION TOOL,” and filed on an even date herewith which is incorporated by reference herein in its entirety.

### TECHNICAL FIELD

The disclosed embodiments generally relate to detecting users of an application exhibiting low hosting activity, and in particular to triggering activity on an application based on detected low hosting activity.

### BACKGROUND

Accommodation management systems list accommodations that host users own or occupy, and enable guest users to book those listed accommodations. These accommodation management systems deploy passive mechanisms where host users must proactively indicate availability of an accommodation for the accommodation to be listed and accessible by potential guest users. Active mechanisms where hosts are reminded to list their accommodations may form a nuisance to a host user who intentionally did not indicate availability of an accommodation. Some users may infrequently or never offer accommodations, despite registering a profile on the system and actively using the system to book stays at the accommodations of others.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system for hosting accommodations.

FIG. 2A illustrates one embodiment of a block diagram of an accommodation management system.

FIG. 2B illustrates one embodiment of the class diagram of the databases of the accommodation management system.

FIG. 3 illustrates one embodiment of a user interface for displaying a user's wish list of accommodation listings.

FIG. 4 illustrates one embodiment of a user interface for displaying an accommodation listing which includes an option to be added to the wish list in FIG. 3.

FIG. 5 illustrates one embodiment of a visualization of future events occurring in a geographic region associated with a user of the accommodation management system.

FIG. 6A illustrates one embodiment of a notification interface on a client mobile device alerting a user of a hosting opportunity corresponding to an upcoming event.

FIG. 6B illustrates one embodiment of an interface displaying a prompt describing a hosting opportunity corresponding to an event.

FIG. 6C illustrates one embodiment of an interface for displaying a priority order of listings on a user's wish list as depicted in FIG. 3.

FIG. 7 illustrates one embodiment of a of a block diagram illustrating components of an example machine able to read instructions from a machine-readable medium and execute them in a processor (or controller).

FIG. 8 illustrates one embodiment of a process for prompting users of the accommodation management system exhibiting low hosting to make an accommodation listing available during a future event.

FIG. 9 illustrates one embodiment of a process for prompting a user of the accommodation management system to host an accommodation listing during a future event.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium that includes outputting a low hosting activity-based recommendation to users of an accommodation management system to make an accommodation listing available during an event in their geographic region.

For example, an event may occur in a region where users have registered accommodations on the accommodation management system that generates a surge in bookings. The accommodation management system may detect the event and identify users in the region who are not listing an accommodation they've registered on the online system during the event. Responsive to identifying these users, the accommodation management system may recommend to the users to make their accommodations available for booking during the event. The recommendation may additionally be curated based on whether the users have indicated a wish list item that would become accessible should the user's accommodation be booked during the event.

To this end and others, in some aspects of the disclosure, the accommodation management system retrieves, from a database, over a network, data associated with users of the accommodation management system registered in a particular geographic location, the data including each user's hosting activity on the system. The accommodation management system determines a future event occurring in the particular geographic region, and identifies users exhibiting low hosting activity in the geographic region from the retrieved users. The accommodation management system determines therefrom whether to output a prompt to each identified user to list an accommodation during the future event.

The data associated with the users may include a wish list for each user containing accommodation listings each user is interested in booking (e.g., based on express or implied feedback from the user). The system determines, based on the data associated with the future event, an estimated hosting value each user may receive from hosting a guest user during the future event. Based on the estimated hosting value, the processor identifies an accommodation listing on each user's wish list by comparing the estimated hosting value to a reservation criterion associated with the accommodation listing. Additionally, the prompt output by the processor to each user includes the accommodation listing from the relevant user's wish list.

### Accommodation Management System Environment

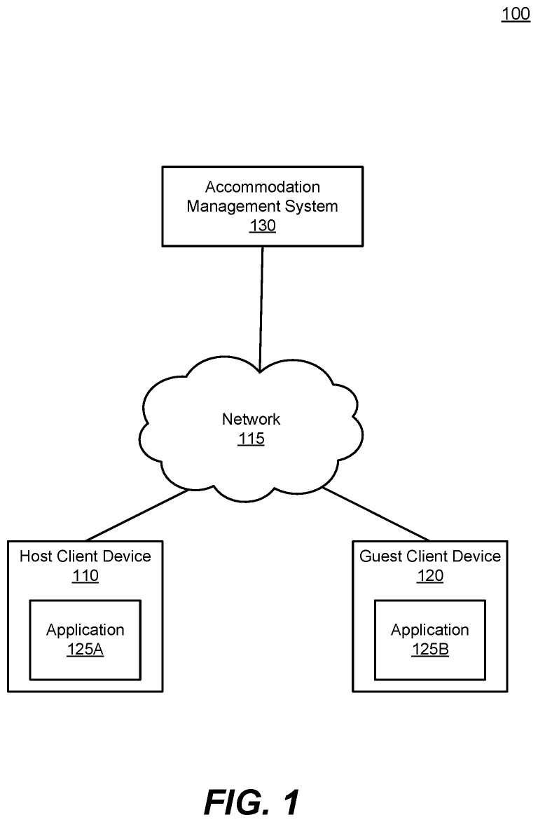

FIG. 1 illustrates one embodiment of a network environment for components of an accommodation management system. Environment 100 includes a host client device 110, a network 115, a guest client device 120, and an accommodation management system 130. Though only one of each type (i.e., host or guest) of client device 110 is shown in FIG. 1, other embodiments may use more than one client device of either type. While not depicted, additional client devices may be included in environment 100 and may be used by service providers, such as third-party entities. These various components are now described in additional detail.

The host client device 110 is a client device of a host user of accommodation management system 130. The term host, as used herein, refers to a user of accommodation management system 130 that lists one or more accommodations on accommodation management system 130. The term guest, as used herein, refers to a user of accommodation management system 130 that books a listed accommodation. Users of the accommodation management system 130 can be a host user, a guest, or both. The term client device, whether used with reference to a host, a guest, or a third-party entity, refers to a computing device such as a smart phone, laptop, computer, or any other device that can interact with the accommodation management system 130 over network 115 consistent with the interactions described herein.

The host client device 110 includes an application 125A, and a guest client device 120 includes an application 125B. The term application, when used in connection with the accommodation management system 130, whether used in reference to a host user, a guest user, or a third-party user, refers to an application capable of carrying out actions relating to use of accommodation management system 130 that are described herein. Examples of such actions include outputting listings for display, completing a booking of a listed accommodation, outputting notifications to a host or a guest, completing a check-in or check-out process, commanding an entry to an accommodation to unlock, and the like. In some embodiments, each of the client devices includes one or more instances of an application 125 associated with the accommodation management system 130. Any number of client devices may be included in environment 100; the depiction of only one of each of host client device 110 and guest client device 120 is merely for convenience.

Network 115 may be any suitable communications network for data transmission. In an embodiment such as that illustrated in FIG. 1, network 115 uses standard communications technologies and/or protocols and can include the Internet. In another embodiment, the entities use custom and/or dedicated data communications technologies. Network 115 connects host client device 110, guest client device 120 (or client devices, in other embodiments), and any other client device, to accommodation management system 130 such that the host client device 110, guest client device, and accommodation management system 130 can transmit data back and forth.

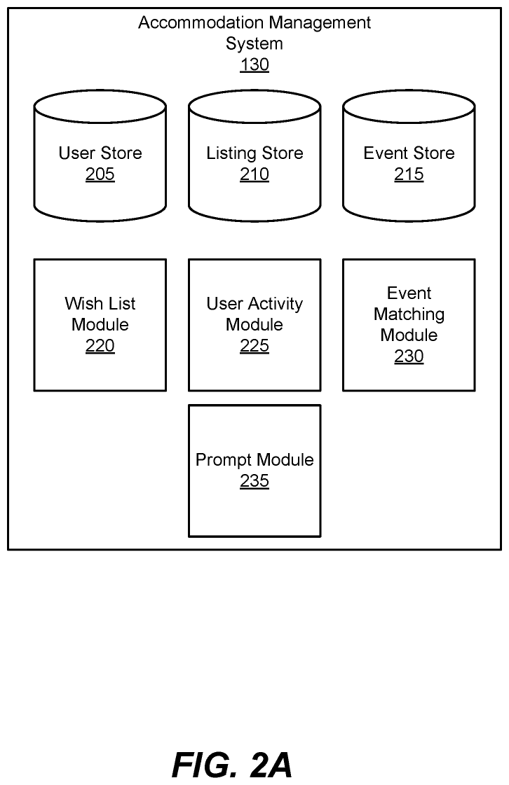

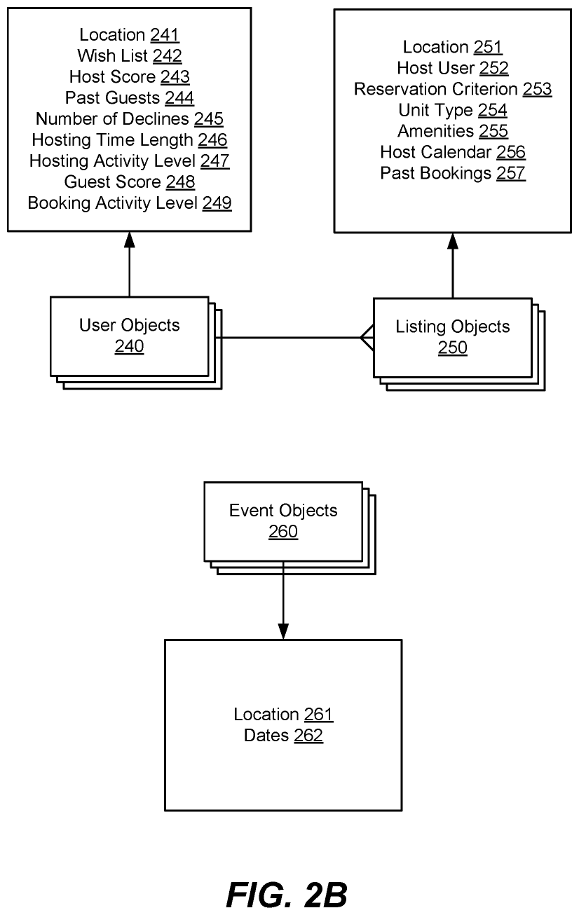

Accommodation management system 130 facilitates activity relating to listing, booking, and physically accessing an accommodation. Further details relating to such activities are described throughout with reference to FIGS. 2-9 below.

### System Environment

FIG. 2A illustrates an embodiment of exemplary sub-modules of an accommodation management system 130 and FIG. 2B illustrates an embodiment of class representations of data stored on the accommodation management system 130. The accommodation management system 130 comprises a user store 205, a listing store 210, an event store 215, a wish list module 220, a low hosting activity identification module 225, an event matching module 230, and a user interface module 235. The various stores (e.g., listing store 205, the user store 210, the event store 215, etc.) are implemented using, e.g., non-transitory computer readable storage devices, and suitable database management systems for data access and retrieval. The modules and data stores depicted with respect to accommodation management system 130 are exemplary; more or fewer modules, classifiers, and data may be used, consistent with the disclosure provided herein.

The accommodation management system 130 persistently stores data describing users (e.g. user characteristics) of the accommodation management system 130 in the user store 205 The term characteristics, as used herein, refers to any data which might be stored by the accommodation management system in the fields of a class representation (e.g. the class representations depicted in FIG. 2B). In particular, the accommodation management system 130 creates a user object 240 (i.e. user profile) for a user when the user registers on the accommodation management system 130 and stores the user objects 240 in the user store 205. User profiles include a name, user name, email address, location 241, phone number, gender, date of birth, personal description, education, work, reviews from other users, pictures, and the like. User profiles may also include a wish list 242 with references to listing objects 250 a corresponding user is interested in booking, which is described in greater detail below with reference to the various fields included in the user objects 240. The user objects 240 for hosts may include additional information such as a host score 243, past guests 244, a number of declines 245, a hosting time length 246, and a hosting activity level 247. Each host may be associated with one or more listings objects 250. The user objects 240 for guests may include additional information such as a guest score 248 and a booking activity level 249. Each user is assigned a unique user ID.

The user location 241 is a field in the user object 240 including an identifier of a geographic location of the accommodation, such as the complete address, neighborhood, city, and/or country of the accommodation offered. In some embodiments, the accommodation management system 130 divides the world into a set of geographic regions, where the user location 241 is inside one of the geographic regions. For example, the world may be divided into a grid of 10 km by 10 km cells, where each cell is a geographic region. The user location 241 may be provided by the user to the accommodation management system 130 when the user registers with the system.

The wish list 242 is a field in the user object 240 including a list of references to listings objects 250 which the user corresponding to the wish list 242 is interested in booking. The wish list 242 may also include one or more dates the user desires to book one or more of the listings in the set of listings. Creation of the wish list 242 is discussed in greater detail below with reference to the wish list module 220.

The host score 243 is a field in the user object 240 including a numerical representation of the user's previous behavior as a host. The host score can be based on the rating assigned by guests from the host's previous bookings. Generally, each time a guest who books an accommodation from a host can provide a rating of the host as well as the accommodation. The ratings are then aggregated into a host score. The ratings can be weighted according to the guests' own scores 311, as well as decayed based on the age of the rating (i.e. how old the rating is). Calculation of the host score 242 is discussed in greater detail below with reference to the user activity module 225.

The past guests 244 is a field in the user object 240 including a count of the number of guests the host has accommodated. In one ne embodiment the past guests 244 is a count of the total number of guests a host has accommodated since the host started using the accommodation management system 130. In another embodiment the past guests 244 only considers the number of guests a host has accommodated in the recent past (e.g. in the past 30 days). Tracking of the past guests 244 is described in greater detail below with reference to the user activity module 225.

The number of declines 245 is a field in the user object 240 including a count of the number of times the host has rejected an accommodation request from a potential guest. A host may decline an accommodation request for any number of reasons. For example, a request from a guest may not have been for a minimum number of days; or the accommodation was not in fact available and the host did not update the listing's calendar, as further described below. Tracking of the number of declines 245 is described in greater detail below with reference to the user activity module 225.

The hosting time length 246 is a field in the user object 240 including a measurement of the amount of time the host has been offering accommodation through the accommodation management system 130. Tracking of the hosting time length 246 is described in greater detail below with reference to the user activity module 225.

The hosting activity level 247 is a field in the user object 240 including a numerical representation of how active the user is in hosting one or more listings. In one embodiment, the hosting activity level 247 represents how frequently the user makes one or more accommodation listings available for booking on the accommodation management system 130. For example, the hosting activity level may indicate how many days in a time range the one or more listings are available (i.e. days within the current year). In another embodiment, the hosting activity level indicates how frequently the user actually hosts a guest user (e.g. has a guest) at one or more listed accommodations. For example, the hosting activity level may indicate how many days in a time range a guest stayed at the one or more accommodations. Determination of the hosting activity level 247 is described in greater detail below with reference to the user activity module 225.

The guest score 248 is a field in the user object 240 including a numerical representation of the user's previous behavior as a guest. In some embodiments, the guest score is based on the scores assigned by users hosting the guest's previous bookings. The guest score 248 shows whether the guest is a frequent user of the accommodation reservation system 130 to book listings, and can be based, for example, on the total number of times a guest has booked an accommodation through the accommodation reservation system 130, the number of times a guest has used the accommodation reservation system 130 in the recent past (e.g. number of accommodations a guest has booked in the past 60 days), the length of time the guest has used the reservation system 130, or a combination of thereof. Determination of the guest score 228 is described in greater detail below with reference to the user activity module 225.

The booking activity level 249 is a field in the user object 240 including a numerical representation of how active the user is in booking a stay at one or more listings. In one embodiment, the booking activity level represents how frequently the user books listings on the accommodation management system 130. In the same or different embodiment, the booking activity level 249 indicates how frequently the user has booked one or more listings within a time frame. Determination of the booking activity level 249 is described in greater detail below with reference to the user activity module 225.

The accommodation management system 130 persistently data describing accommodations offered by hosts (i.e. listing characteristics) in the listing store 210 In particular, the accommodation management system 130 creates a listing object 250 for an accommodation when a user registers and/or lists an accommodation on the accommodation management system 130 and stores the listing objects 250 in the listing store 210. Each offering of a given accommodation is represented by a listing object 250. Information about a listing includes the location 251, the host user 252, the reservation criterion 253, the unit type 254, the amenities 255, and the calendar 256. The listing store 220 may contain additional information such as a short description of the accommodation, a list of house rules, photographs, etc. Each listing is assigned a unique listing ID. Each listing is associated with a single host user 251.

The listing location 251 is a field in the list object 250 including an identifier of the geographic location of the accommodation, such as the complete address, neighborhood, city, and/or country of the accommodation offered. The listing location 251 may be included in geographic region, as discussed above with reference to the user location 241. The accommodation management system 130 adds the listing location 251 with a listing object 250 when a user creates the listing associated with the listing object 250.

The host user 252 is a field in the listing object 250 including an identifier of one of the users which created the listing object 250 and hosts the accommodation associated with the listing object 250. For example, the host user 252 may specify the user ID of the user who created the listing. Each listing 220 is associated with a single host user 251. The accommodation management system 130 may associate the host user 252 with the listing object 250 when a user of the accommodation management system 130 creates the relevant listing.

The reservation criterion 253 is a is a field in the listing object 250 including a requirement a user must satisfy in order to book a listing. For example, the reservation criterion 253 may be the amount of money a guest needs to pay in order to book the listed accommodation. The price may be specified as an amount of money per day, per week and/or per month, or other period of time specified by the host. Additionally, the price may include additional charges such as cleaning fee, pet fee, and service fees. As another example, the reservation criterion 253 may be a task a user is required to complete on the accommodation management system in order to earn a booking of the listing. Required tasks might include hosting a guest during an event, listing an accommodation as available during an event, or hosting a certain number of guests at an accommodation over a certain time period. Determination of the reservation criterion 253 is described in greater detail below with reference to the event matching module 230.

The unit type 254 is a field in the listing object 250 including a description of the type of accommodation being offered by the host. Embodiments classify unit type into two groups, room type and property type. Types of room include entire home or apartment, private room, and shared room. Types of property include apartment, house, bed & breakfast, cabin, villa, castle, dorm, treehouse, boat, plane, parking space, car, van, camper or recreational vehicle, igloo, lighthouse, yurt, tipi, cave, island, chalet, earth house, hut, train, tent, loft, and the like. The accommodation management system 130 may associate the unit type 254 with the listing object 250 when a user of the accommodation management system 130 creates the relevant listing and indicates a unit type.

The amenities 255 is a field in the listing object 250 including a description of additional features that an accommodation offers. Amenities include smoking allowed, pets allowed, TV, cable TV, internet, wireless internet, air conditioning, heating, elevator, handicap accessible, pool, kitchen, free parking on premise, doorman, gym, hot tub, indoor fireplace, buzzer or wireless intercom, breakfast, family or kid friendly, suitable for events, washer, drier, and the like. The accommodation management system 130 may associate the amenities 255 with the listing object 250 when a user of the accommodation management system 130 creates the relevant listing and indicates the amenities.

The host calendar 256 is a field including the availability of the accommodation for each date in a date period, as specified by the host. That is, a host accesses the host calendar 256 for a listing, and manually indicates which dates that the listing is or is not available. The host specified calendar also includes information about the dates that the accommodation is unavailable because it has already been booked by a guest. Creating and updating the host calendar 256 is described in greater detail below with reference to the user activity module 225.

The accommodation management system 130 persistently stores data describing detected events (i.e. event characteristics) taking place at locations in regions with listings on the online accommodations system 130 in the event store 215. In particular, the accommodation management system 130 creates an event object 260 when an event is detected and stores the event object 260 in the event store 215. Information stored in the event objects 260 include an event name, event description, event location 261 and event dates 262. The event objects 260 may additionally include information describing listings in the same geographic region as the event, such as predicted booking rates or predicted listing prices during the event. Each event is assigned a unique event ID. The term event, as used herein, represents one or more dates and times the accommodation management system 130 has classified as being likely to have increased booking activity in a geographic region based on data describing the dates meeting one or more event criteria. The accommodation management system 130 may detect events which correspond to actual organized activities taking place on one or more dates, such as music festivals, sporting competitions, and conventions. Additionally, the accommodation management system 130 may detect events based on a historical or predicted increase in booking activity on the accommodation management system 130 on one or more dates which are associated with any known organized activity. In some embodiments, an event object 260 may be manually created by an administrator of the accommodation management system 130. The event criteria used on the accommodation management system 130 to classify dates as events is described in greater detail below with reference to the event matching module 230.

The event location 261 is a field in the event object 260 including an identifier of the geographic location of the event, such as the complete address, neighborhood, city, and/or country where the event is occurring. The event location 261 may be included in geographic region, as discussed above with reference to the user location 241 and the listing location 251. If the event is not associated with any known organized activity then the location 261 may be a default location within the associated geographic region or may just describe the geographic region itself. Determination of the event location 261 is described in greater detail below with reference to the event matching module 230.

The event dates 262 is a field in the event object 260 including one or more dates on which the event is occurring at the event location 261. Determination of the event dates 262 is described in greater detail below with reference to the event matching module 230.

The wish list module 220 adds references to listing objects 250 to the wish list 242 associated with the user. In some embodiments, the wish list module 220 receives a listing object 250 in response to an interaction by the user with the accommodation management system 130 and adds a reference to listing object 250 (e.g. the unique listing ID) to the wish list 242. In the same or different embodiments, the wish list module 220 automatically adds listing objects 250 to the wish list 242. The wish list module 220 may determine which listing objects 250 to add to the wish list 242 based on the data included in the listing store 205, the user store 210, the event store 215, or some combination thereof.

In some embodiments, the wish list module 220 uses a machine learned, predictive model to determine listing objects 250 to automatically add to the wish list 242 (i.e. a wish list model). In one embodiment, a supervised machine learning algorithm, such as support vector machine is used to construct the wish list model. In other embodiments, other machine learning algorithms, such as neural network, random forest or any other supervised learning algorithms may be used to build the wish list model.

In some embodiments, the wish list module 220 notifies a user corresponding to a wish list 242 that they have earned a stay at an accommodation listing on the wish list 242 based on completing one or more hosting milestones. For example, a milestone may correspond to host user hosting a certain number of guest users (e.g. 100 guest users) at their accommodation listed on the accommodation management system 130. As another example, a milestone may correspond to a host user having hosted guest users for a certain length of time (e.g. hosting guest users for 5 years). A milestone may also correspond to a host user hosting during one or more events, which is described in greater detail throughout the specification. When a host user reaches a hosting milestone, the wish list module 220 may notify the host user by sending a notification to a client device corresponding to the host user (e.g. host client device 110) indicating an accommodating listing referenced on the user's wish list 242 which the host user can now book for free or at a discounted rate. Furthermore, the wish list module 220 may select an accommodation listing referenced on the user's wish list 242 which is commensurate with the achieved milestone. For example, the wish list module 220 may determine that the selected accommodation listing has a corresponding reservation criterion matching the achieved milestone based on one or more rules (e.g. if the user hosts 100 guests, select an accommodation listing which costs less than $200 a night).

The user activity module 225 tracks the activity of users on the accommodation management system 130. Tracked user activity includes data describing hosting accommodation activity by the user (i.e. hosting data), booking accommodation activity by the user (i.e. booking data), browsing accommodation activity by the user (i.e. browsing data), communication by the user with other users (i.e. communication data), and any additional interactions by the user with the accommodation management system. The user activity module 225 updates the fields of the user objects 240 and the listings 250 in response to the tracked user activity. In particular, the user activity module 225 updates the host score 243, the past guests 244, the number of declines 245, the hosting time length 246, the hosting activity level 247, the guest score 248, the booking activity level 249, the host calendar 256, and the past bookings 257. Additionally, the user activity module 225 updates fields of the listing objects 250 in response to the listing being booked or made available (e.g. updating host calendar 256). The user activity module 225 may determine the hosting activity level 247 and the booking activity level 249 based on the values stored in the user objects 240 or the listing objects 250. For example, the hosting activity level 247 may be determined based on one or more of the host score 243, past guests 244, number of declines 245, hosting time length 246, or additional data stored by the accommodation management system. Similarly, the booking activity level 249 may be determined based on one or more of the guest score 248, a total number of bookings the user has made, a number of bookings the user has canceled, a booking frequency within one or more time frames, and additional data stored on accommodation management system 130. The hosting activity level 247 and booking activity level 249 may be updated periodically (e.g. once per day), or in response to user interactions (e.g. every time the user hosts an accommodation).

In some embodiments, the user activity module 225 identifies users with a low hosting activity level 247 (i.e. low hosting activity users) and provides references to these users (e.g. user objects 240) to other components of the accommodation management system 130. User activity module 225 may determine that a user is a low hosting activity user responsive to determining that hosting activity level 247 is below a low activity user threshold value stored in a database included in the accommodation management system 130. In some cases, the user activity module 225 may determine that a user is a low hosting activity user if the user is not currently listing an accommodation or has not listed an accommodation within some time frame. The same low hosting activity threshold may be applied to all users, or the threshold may be determined based on the context of individual users. For example, low activity thresholds may be determined for individual geographic regions, date ranges, listing characteristics, or any combination thereof.

The event matching module 230 detects future events and matches users to the detected events in order to prompt the users to host an accommodation during the matched event. In response to detecting an event, the event matching module 230 creates an event object 260 associated with the event and stores the event object 260 in the event store 215. The event matching module 230 matches users to events by comparing data describing a given user (e.g. user objects 240) to data describing a given event (e.g. event objects 260), such as the relevant locations and event dates 262. For example, the user location 241 and the event location 261 may both be in the same geographic region defined by accommodation management system 130. Additionally, the event matching module 230 may match the user to events based on the event dates 262. For example, the event matching module 230 may determine from the past bookings 257 of a listing that the host user 252 frequently hosts during certain dates and never hosts during others.

In some embodiments, the event matching module 230 detects events by fetching data from one or more third-party systems (e.g. social networks, social media platforms, ticket marketplaces, etc.) and processes the data in order determine that an actual event is occurring at a location 261 on one or more dates 262. For example, the data may include trending topics on a social media platform. In this case, the event matching module 230 may extract and process event related topics to infer an event is occurring on one or more dates. As another example, the data may explicitly describe events, such as an upcoming concert on a ticket marketplace.

In some embodiments, the event matching module 230 detects events by analyzing data associated with listings on the accommodation management system 130 (e.g. listing objects 250). For example, the event matching module 230 may determine that the average booking prices (e.g. based on the reservation criteria 253) of listings in a geographic region on one or more future dates are above an event threshold. As another example, the event matching module 230 may determine that the historical booking prices 254 of listings in a geographic region increased on one or more dates in a previous time frame (e.g. week, month, year), and from this predict that similar booking price behavior will occur on the one or more dates in the current time frame.

In some embodiments, the event matching module 230 determines an estimated hosting value to the user for hosting an accommodation during the event. The event matching module 230 may determine the estimated hosting value based on the data associated with listings in the same geographic region as the event. For example, the event matching module 230 may determine the estimated hosting value based on the reservation criterion 253 of one or more listings in the same geographic region as the event. Additionally, the event matching module 230 may consider additional data describing listings (e.g. the unit type 254 and the amenities 255), past booking history (e.g. past bookings 257), and previous bookings of listings during the event or other similar events. In some cases, the event matching module 230 may determine the estimated hosting value for hosting a listing associated with a user (e.g. where the user is the host user 252). In other cases, such as when there is no listing associated with a user, the event matching module 230 may determine a generic estimated hosting value for hosting during the event based on aggregated data stored for the listings.

The event matching module 230 may use a machine learned, predictive model to determine the estimated hosting value (i.e. a hosting value model). Additional embodiments of the event matching module 230 use a machine learned, predictive model to predict whether a user would make an accommodation listing available during a given future event (i.e. an event model). In one embodiment, a supervised machine learning algorithm, such as support vector machine is used to construct the hosting value model. In other embodiments, other machine learning algorithms, such as neural network, random forest or any other supervised learning algorithms may be used to build the hosting value model.

In some embodiments, the event matching module 230 matches users to events based on accommodation listings on a given user's wish list 242. The prompt module 235 may compare each of the listings on a user's wish list 242 to the estimated hosting value of the event to determine a listing with a matching estimated booking value. The estimated booking value may be determined based on the reservation criterion 253, unit type 254, amenities 255, host calendar 256, past bookings 257, additional historical data, or any combination thereof. Furthermore, the event matching module 230 may identify several listings on the wish list which have estimated booking values that meet a criterion based on the estimated hosting value. In this case, the event matching module 230 selects one or more listings from the several listings and provides the listing objects 250 associated with the one or more selected listings to other components of the accommodation management system 130 (e.g. the prompt module 235) for inclusion in a prompt. Additionally, the event matching module may not find any listing on the user's wish list 242 with an estimated booking value matching the estimated hosting value based on the criterion. In this case, the event matching module 230 may not match the user to the event and accommodation management system 130 may not proceed to prompt the user to host during the event. In one embodiment, the prompt module 235 selects listings on a user's wish list 242 which have availability during the relevant event, and may further prompt the user to host during the event while also staying at the accommodation corresponding to the selected listing.

Additional embodiments of the event matching module 230 use a machine learned, predictive model to predict whether a user would make an accommodation listing available during a given future event (i.e. a listing likelihood model). The event matching module 230 may use the output of the listing likelihood model to determine whether the accommodation management system 130 should proceed to match the user to an event and prompt the user to host during the event. For example, the accommodation management system 130 may avoid unnecessarily sending users notifications based on the output of the listing likelihood model, as this could result in the users stopping any interaction with the system altogether. In one embodiment, a supervised machine learning algorithm, such as a support vector machine, is used to construct the listing likelihood model. In other embodiments, other machine learning algorithms, such as neural network, random forest or any other supervised learning algorithms may be used to build the listing likelihood model.

The prompt module 235 receives user objects 250 matched with event objects 260 and prompts the users associated with the user objects 240 to host an accommodation during the events associated with the matched event objects 260. The prompt module 235 may initiate prompting the users by sending notifications to client devices associated with users. The prompt may include details about the relevant event, the estimated hosting value for hosting during the event, and interactable interface elements configured to facilitate the users accepting to make an accommodation available during the event.

In some embodiments, the prompt module 235 may receive one or more references to accommodation listings included in the matched user object's wish list 242. In this case, the prompt module 235 includes descriptions of the one or more accommodation listings from the wish list 242 in the prompt and indicate that the user may be able to book the accommodation listings if they host during the event. In the same or different embodiments, the prompt module 235 may receive one or more references to accommodation listings which the user corresponding to the matched user object has booked on future dates. In this case, the prompt module 235 may include descriptions of one or more booked accommodation listings from the wish list 242 in the prompt and may indicate that the user may be able to book the accommodation listings if they host during the event. Furthermore, the prompt module 235 may perform any of the same processing discussed below in relation to including accommodation listings referenced on the wish list 242 on the booked accommodation listings when prompting a user to host during an event.

### Wish List Creation and Management

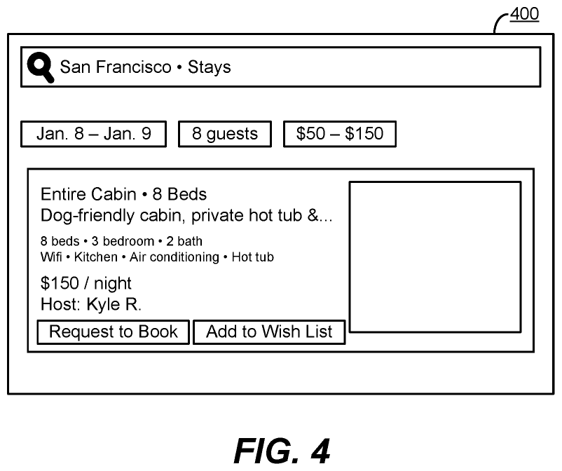

Users of accommodation management system 130 create and manage personal wish lists that include accommodation listings the users are interested in booking. A user's wish list 242 may be initialized when the user creates a profile on the accommodation management system 130, or may be created later when a first listing is selected for inclusion in the wish list 242. Listings on a user's wish list 242 may specify particular dates the user is interested in booking the listing, or may instead be open ended (i.e. indicate the user's general interest in booking without particular dates). The wish list module 220 adds references to listing objects 250 to the wish list 242 associated with the user. In some embodiments, the wish list module 220 receives a request to add a reference to a listing to the wish list 242 in response to a user interaction with the listing, which is described in more detail below with reference to FIG. 4. In the same or different embodiments, the wish list module 220 automatically identifies listings which the user may be interested in booking and adds a reference to the listing to the user's wish list 242, which is described in more detail below with reference to the wish list model.

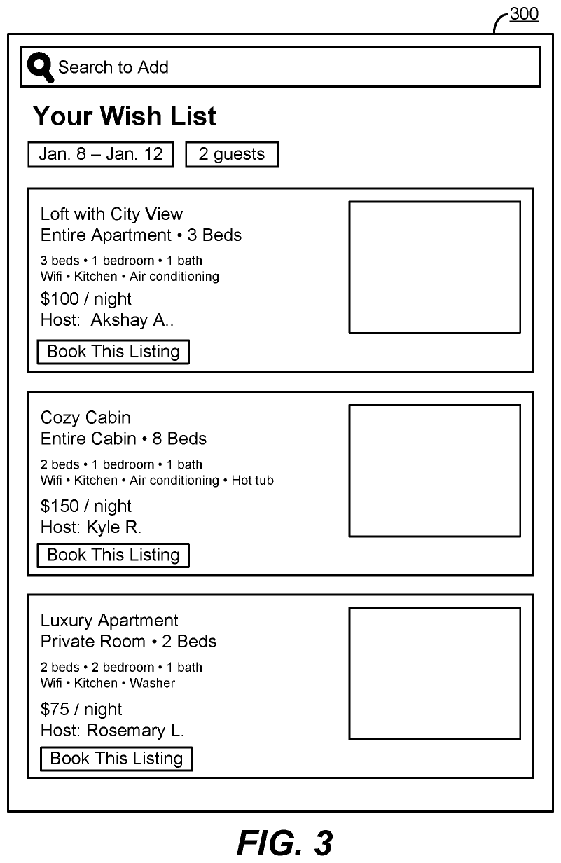

FIG. 3 illustrates one embodiment of a user interface 300 for displaying the accommodation listings referenced in a user's wish list 242. The accommodation management system 130 provides for display the interface 300 on a user client device. Each listing displayed on the interface 300 includes relevant information about each listing from the associated listing object 250, such as the location 251, the host user 252, the reservation criterion 253, the unit type 254, etc. The accommodation management system 130 filters the listings on the wish list 242 based on the selection parameters depicted in FIG. 3 and provides for display the information about the filtered listings. In this case, the selection parameters include the availability during a particular date range (January 8^{th} to January 12^{th}) and room for a certain number of guests (2 guests). Responsive to adjustment of the selection parameters, the accommodation management system 130 updates the display of the listings on interface 300. If no selection parameters are specified, then the accommodation management system 130 may provide all of the listings referenced in the user's wish list 242 for display on interface 300. The accommodation management system 130 additionally provides for displays a search field for querying the accommodation management system 130 for more listings which the user might add to the wish list. In response to query input by a user to the search field (e.g. the name of a city), the accommodation management system 130 queries the listing store 210 for listing objects 250 matching the query input and updates the interface 300 based on the query results.

FIG. 4 illustrates one embodiment of a user interface 400 for displaying an accommodation listing which includes an option to be added to the wish list in FIG. 3. Similar to interface 300, the accommodation management system 130 provides for display the interface 400 on a user client device. The interface 400 includes relevant information about the listing included in the associated listing object 250. The description of the listing provided for displayed by the accommodation management system 130 on interface 400 also includes an interactable object (e.g. a virtual button) which a user may select in order to add a reference to the displayed listing to the user's wish list 242. In response to a user selection of the interactable object, the accommodation management system 130 adds a reference to the displayed listing to the wish list 242 (e.g. by the wish list module 220).

In some embodiments, the wish list module 220 creates and uses the wish list model to identify and automatically add references to listings to the user's wish list 242. Embodiments of the wish list model train on data stored in the user store 205 and the listing store 210, as well as user activity data provided by the user activity module 225 or other components of the system 100. The wish list module 220 trains the wish list model to predict the likelihood that a given user would book a given listing. The wish list model may take into account information about the user (e.g., gender, location 241, wish list 242, and/or booking activity level 249) and/or information about the listing (e.g., location 251, host user 252, reservation criterion 253, unit type 254, and/or amenities 255).

In some embodiments, to develop the wish list model, the wish list module 220 accesses data describing user activity on third-party systems and incorporates this data in training the wish list model. For example, the wish list module 220 may access user activity data from one or more social network systems, one or more third-party accommodation systems, or one or more search engines. The accessed user activity data may include information about the user's interests (e.g. travel destinations, hobbies, education), the user's movement history (e.g. where the user has visited), or the user's dislikes (e.g. negative reviews of venues in certain locations). This information may then be used to determine whether a user would book a listing. This information may be aggregated for a plurality of users and used to train the wish list model.

In some embodiments, to develop the wish list model, the wish list module 220 computes all the training parameters for a plurality of users and listings and determines for each listing whether each user booked the listing. In one embodiment, a probability function is constructed for every training parameter and an overall probability of the user booking the listing is computed by multiplying the individual probabilities.

For example, the wish list module 220 may create a probability function that calculates the likelihood that the user object 240 would book the listing object 250 depending on the gender of the user (e.g., P(book|user_is_male), P(book|user_is_female), or P(book|user_geneder_is_unkonwn). The wish list module 220 may also create a probability function that the user object 240 would book the listing object 250 given additional parameters (e.g., P(book|user_location), P(book|user_host_activity_level), P(book|user_wish_list), etc.). Furthermore, the acceptance module 230 may also create probability functions based on information about the listing (e.g., P(book|listing_location), P(book|price), or P(book|amenities), P(book|user_is_male), etc.), user activity data on third-party systems (e.g., P(book|user_hobbies), P(book|user_travel_history), P(book|user_education), etc.), and the like.

After the wish list module 220 has constructed the wish list model, it can be used to calculate the probability that the user will book the listing. The wish list module 220 can compute the different probabilities associated with a given user and listing and determine an overall probability of the user booking the accommodation (PB), for example:

PB=P(book|user_gender)×P(book|user_location)×P(book|listing_location)×P(book|listing_price)×P(book|user_hobbies)

In another embodiment, the wish list module 220 encodes information from a given user object 240, a given listing object 250 and/or the user's activity information on the accommodation management system 130 or a third-party system. Then the accommodation management system 130 labels the feature vector based on whether the given user has booked the given listing. In this case, the wish list module 220 trains the wish list model using a plurality of such feature vectors to output a likelihood that the user booked the listing.

In the same or different embodiments, the wish list module 220 may train the wish list model to predict a user's rating of a stay at a given listing. In this case, the wish list model will be trained using data corresponding to users and listings wherein the user did book a stay at the listing and provided a rating for the stay. In this way, the wish list module 220 may only add a listing to a user's wish list 242 when the rating predicted by the wish list model exceeds a certain threshold.

In one embodiment the wish list module 220 updates the wish list model periodically (e.g., every night). In some embodiments, the wish list module 220 generates a wish list model using data from users that have been using the accommodation management system 130 for at least a threshold amount of time (e.g., users that have had a user profile at least 3 months).

In additional embodiments, the wish list module 220 uses other techniques to identify and automatically add references to listings to the user's wish list 242. The wish list model 220 may use a rule based approach to identify listings the user may be interested in booking. In this case, the wish list module 220 may receive metrics regarding a user's activity data from the user activity module 225 and use the metrics to determine whether a user is interested in booking a listing. For example, the user activity module 225 may add to the wish list 242 a reference to a listing which the user has looked at on the accommodation management system a threshold number of times. As another example, the user module 225 may add to the wish list 242 a reference to a listing which the user has looked at on the accommodation management system 225 and which shares a certain number of characteristics (e.g. location 251, reservation criterion 253, unit type 254, etc.) with other listings for which the user has previously manually added references to the wish list 242. One skilled in the art will recognize that additional rule based approaches processing user activity data are possible.

In various embodiments, the wish list module 220 additionally adds references to event objects 260 to the wish list 242 associated with a user. For example, a user may wish to generally attend an event rather than stay at any particular accommodation listing. In this case, event objects 260 may be added to the wish list 242 in any of the ways discussed above in relation to adding references to listing objects 250 to the wish list 242, such as manual user input or with a machine learned predictive model. The wish list module 220 may further use an event object 260 referenced on a wish list 242 corresponding to a user to determine listing objects 260 to add to the wish list 242. For example, the wish list module 242 may search for accommodations within a threshold distance from the relevant event, and additionally may use any of the methods discussed above in relation to adding listing objects 250 to the wish list 242. Furthermore, a user may be prompted by prompt module 235 to host during an event in order to earn a stay at an accommodation for a particular event on their wish list.

### Prompting Low Hosting Activity Users to Host

### A. Identifying Low Hosting Activity Users

The user activity module 225 identifies low hosting activity users and provides the user objects 240 corresponding to the identified users to other components of the accommodations management system 130 in order to prompt the low activity users to host. The user activity module 225 may periodically determine low activity users (e.g. once a day), or may responsively identify low activity users, such as in response to receiving a new event, as described in detail below with reference to the event matching module 230.

In some embodiments, the hosting activity module 225 identifies users registered in a particular geographic region who are not currently associated with a listing with availability on one or more dates as low activity users. A listing is available on a date when the host calendar 256 indicates that the accommodations can be booked on the date. As such, users who do not currently have a listing available on one or more dates are users for which there is no listing object 250 which the user is the host user 252 and one or more dates in the host calendar 256 are available for booking. The hosting activity module 225 may apply additional constraints when identifying low hosting activity users, such as only identifying users associated with a listing (e.g. a listing where the user is the host user 252).

In some embodiments, the hosting activity module 225 identifies low hosting activity users based on the users' hosting activity level 247 dropping below a threshold. For example, if the hosting activity module 225 determines the hosting activity level 247 by computing how many days a user listed an accommodation in the previous year, the threshold for low hosting activity applied by the hosting activity module 225 might be 10 days or less. In the same or different embodiments, the applied threshold may be determined by the hosting activity module 225 for each of a set of geographic regions defined by the accommodations management system 130. In this case, regions determined by the hosting activity module 225 to have relatively high booking activity (e.g. high host scores 243, high booking prices, busy listing host calendars 256, listings with many past bookings 257, etc.) may have strict low hosting activity thresholds (i.e. higher hosting activity levels are considered low hosting activity). Similarly, regions determined by the hosting activity module to have relatively low booking activity may have generous low hosting activity thresholds (i.e. only low hosting activity levels are considered low hosting activity). Similar techniques may be applied by the hosting activity module 225 to determine low hosting activity thresholds for specific date ranges, listings with certain characteristics, users with certain characteristics, or any combination thereof.

Upon identifying a set of low hosting activity users that satisfy one or more of the criteria described above, the user activity module 225 provides the user objects 240 corresponding to the users to other components of the accommodations management system 230. For example, the user activity module 225 may provide the user objects 240 corresponding to the low hosting activity users to the event matching module 230, as is described in the following section.

### B. Matching Users with Events

The event matching module 230 detects events and receives user objects 240 from other components of accommodation system 130 (e.g. the user activity module 225) in order to match one or more users with the detected events. In particular, the event matching module 230 attempts to match each user associated with the received user object 240 to a detected future event with an event location 261 in the same geographic region as the user's location 241. If a user is matched with a future event, the event matching module 230 provides the user object 240 associated with the user and the event object 260 associated with the matched future event to other components of the accommodation management system 130 for use in prompting the user to host during the event. The event matching module 230 may match a user to an event based on an estimated hosting value to the user (e.g. price charged to a guest) of hosting an accommodation listing during the event. Furthermore, the event matching module 230 may compare the estimated hosting value of an event to the reservation criterion 253 of listings on the user's wish list 242 and determine whether one or more listings matches the event based on the comparison.

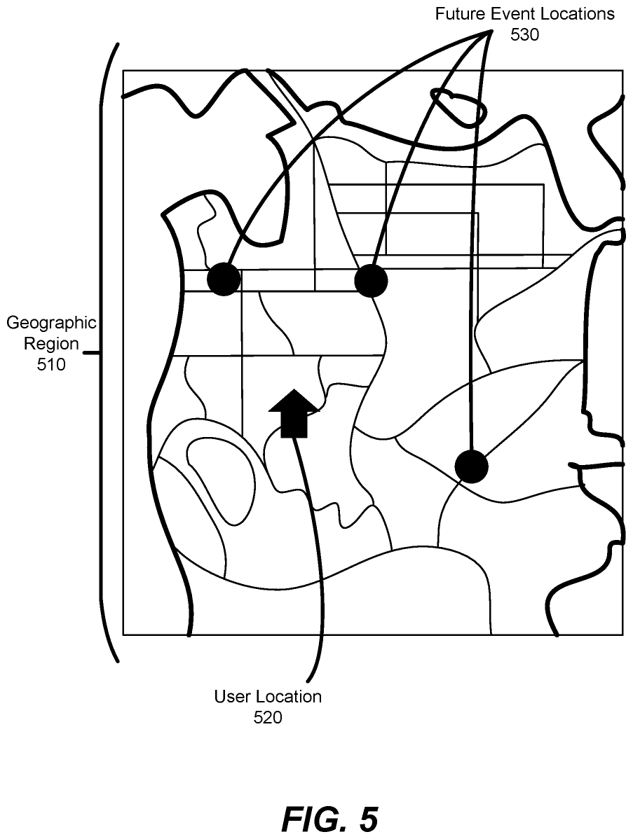

FIG. 5 illustrates one embodiment of a visualization of future events occurring in a geographic region 510 associated with a user of the accommodation management system. In particular, the geographic region 510 represents San Francisco and includes the user's location 520 as registered on the accommodation management system 130 and the future event locations 530. As described above in relation to the user location 241, the listing location 251, and the event location 261, the accommodation management system 130 may divide a representation of the Earth into a set of geographic regions. In this case, the user is matched with other events in the same geographic region 510. In other embodiments, the event matching module 130 matches the user to events within some distance from the user's location 520 (e.g. within 10 miles). The user's location 520 may be a home address provided by the user (e.g. user location 241), or the location of a listing for which the user is the host user 252 (e.g. listing location 251). The future event locations 530 are the locations of various events (e.g. concerts, sporting competitions, conventions, etc.) each occurring on one or more future dates. As described above in reference to the event objects 260, the detected events may correspond to observed increases in reservation criteria 253 (e.g. prices) in a region, rather than any organized activity occurring in a physical location. In this case, the future event locations 530 may be approximated locations based on which reservation criteria 253 the event matching module 230 considered when detecting the events. In additional embodiments, events detected based increased reservation criteria 253 may not be associated with any locations at all, and instead event matching module 230 may match the user with events based on the proximity of the user's location 520 to the location of listings used to detect the events.

In some embodiments, the event matching module 230 creates and uses the hosting value model to determine the estimated hosting value of hosting an accommodation associated with the user during the event. Embodiments of the hosting value model train on data stored in listing store 210 and the events store 215, as well as user activity data provided by the user activity module 225 or other components of the system 100. The event matching module 230 trains the hosting value model to predict the estimated hosting value for a given listing during a given event. The estimated hosting value may represent the estimated amount of money the user would earn if the given accommodation was hosted, or it may represent additional factors such as the estimated increase to the user's host score 243 or hosting activity level 247. In particular, embodiments of the hosting value model can take into account information about the listing (e.g., location 251, host user 252, reservation criterion 253, unit type 254, and/or amenities 255) and/or information about the event (e.g. location 261, dates 262, previous booking history of the event, etc.).

In some embodiments, the user activity module 225 may encode various training parameters corresponding to listings which were booked during events in feature vectors and label the feature vectors based on the actual value gained by a host user from hosting the listing. For example, each feature vector may encode the geographic region of the listing location 241 and event location 261 and the event dates 262, and label the feature vector with the combined value of hosting during the event based on the reservation criterion 253. Then, the hosting value model may be trained using a plurality of such feature vectors derived from a plurality of listing objects 250 and corresponding event objects 260.

In some embodiments, the user may not be associated with an accommodation listing (e.g. a listing where the host user 252 specifies the user object 240 associated with the user). In this case, the event matching module 230 may determine the estimated hosting value without reference to specific accommodation listing. In one embodiment, the event matching module 230 determines parameters corresponding to a generic listing. For example, the event matching module 230 may process a plurality of listing objects 250 in the same geographic region as an event to determine average listing parameters for that particular geographic region. Given these average listing parameters, the event matching module may proceed to determine the estimated hosting value using the same method as with an actual listing (e.g. use the hosting value model). In the same or different embodiment, the event matching module 230 determines the parameters of the generic listing based on data describing the received user. For example, the received user may have previously booked listings with significantly higher than average reservation criteria 253. As such, the event tracking module 230 may adjust the generic listing's parameters to reflect a more extravagant listing on the assumption that the user has higher than average wealth.

In some embodiments, the event matching module 230 compares the event object 260 to the user's wish list 242 in order to determine whether the user object 240 matches the event 260. The event matching module 230 may determine an estimated booking value for a plurality of listings on the user's wish list 242. In this case, the prompt module 235 determines a listing on the wish list 242 with an estimated booking value that meets a criterion relative to the matched event's estimated hosting value. For example, the event matching module 230 may select a listing on the wish list 242 with the closest estimated booking value to the event's estimated hosting value. As another example, the event matching module 230 may only select a listing on the wish list 242 with an estimated booking value that is less than the event's estimated hosting value. If the event matching module 230 identifies a listing on the wish list satisfying the criterion, then the user is matched with the event. The event matching module 230 then provides details included in the listing object 250 corresponding to the listing from the wish list for inclusion in the prompt presented to the user on the user's client device. In various embodiments the prompt includes descriptions of a plurality of events and a plurality of wish list listings, wherein the user selects one or more events and one or more listings by interacting with the prompt. If the event matching module 230 does not identify a listing on the wish list 242 satisfying a criterion, then the user is not matched with the event and the accommodation management system 130 does not proceed to prompt the user to host.

In some embodiments, the event matching module 230 predicts whether the user associated with the received user object 260 will make a listing available during the event the user is matched with. In this case, the event matching module 230 makes the prediction based on various data tracked by the user activity module 225, stored in the user store 205, stored in the listing store 210, or stored in the event store 215. For example, the user activity module 225 may determine the prediction based on the user's host score 243, past guests 244, number of declines 245, hosting time length 246, guest score 248, or booking activity level 249, or some combination thereof. The event matching module 230 may require the prediction to indicate that the user will host during the matched event in order to provide the user object 240 associated with the user for prompting.

In some embodiments, the event matching model 230 creates and uses the listing likelihood model to predict whether a user matched with an event is going to list an accommodation during the event. Some embodiments of the listing likelihood model train on data stored in the user store 205, the listing store 210, and the events store 215, as well as user activity data provided by the user activity module 225 or other components of the system 100. In particular, embodiments of the listing likelihood model can take into account information about the user (e.g., gender, location 241, wish list 242, hosting activity level 249), information about a listing which the user is associated with (e.g., location 251, host user 252, reservation criterion 253, unit type 254, and/or amenities 255), and the event the user is matched with (e.g. event location 261, event dates 262, event description, event title, etc.).

In some embodiments the event matching module 230 may encode the various training parameters (e.g. user objects 240, listing objects 250, and event objects 260) in feature vectors and label the feature vectors regarding whether a given user made a listing for an accommodation associated with the user available during a given event. In this case, the listing likelihood model may be trained using a plurality of feature vectors to predict whether a given user would make a listing available for an accommodation during the given event. In one embodiment, the event matching module 230 trains the listing likelihood model based on data associated with users who frequently make a listing available for an accommodation (e.g. users that have a high hosting activity level 247).

Upon matching the user associated with the received user object 240 with an event, the event matching module 230 provides the relevant user object 240, event object 260, and estimated hosting value to other components of the accommodations management system 230. For example, the event matching 230 may provide the user object 240 and event objects 260 to the prompt module 235, as is described in the following section.

### C. Prompt Generation

The prompt module 235 receives a user object 240 matched with an event object 260 associated with a future event from the event matching module 230 and prompts the user associated with the user object 240 to host an accommodation during the future event. In particular, the prompt module 235 recommends that the user hosts an accommodation during the future event based on the likelihood of higher booking rates and prices during the event. As such, the prompt module 235 generates a prompt which includes details of the future event and provides interaction capability for the user to initiate hosting a listing during the event. In particular, the prompt may allow the user to make an existing listing available for the event dates 262. The prompt module 235 may additionally receive a listing object 250 associated with a listing included on the user's wish list 242 and include details about the listing in the prompt, as is described above in relation to the event matching module 230.

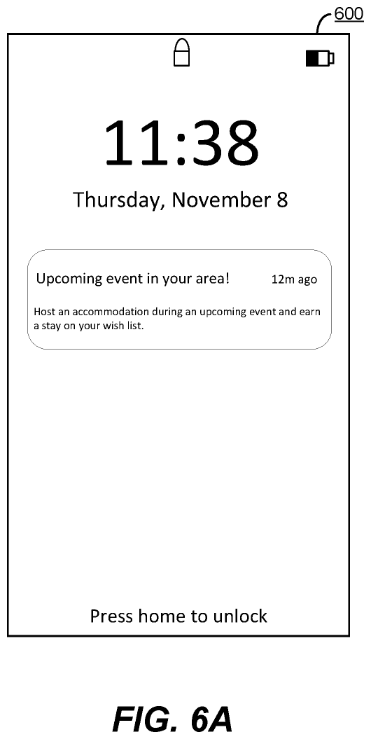

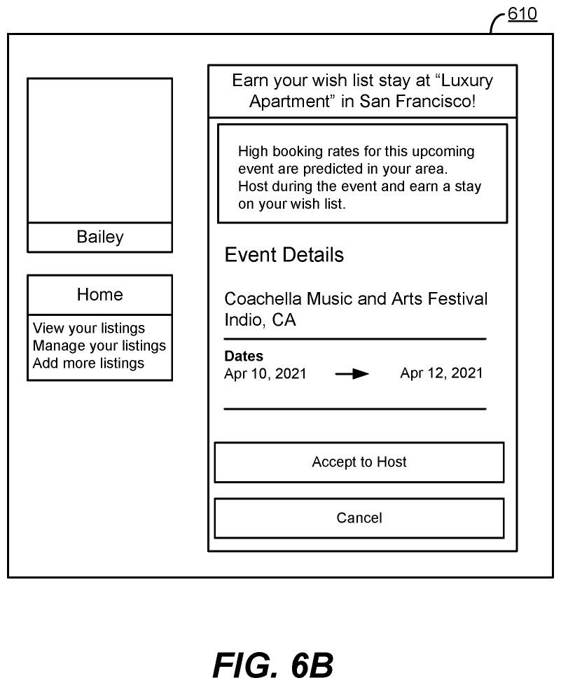

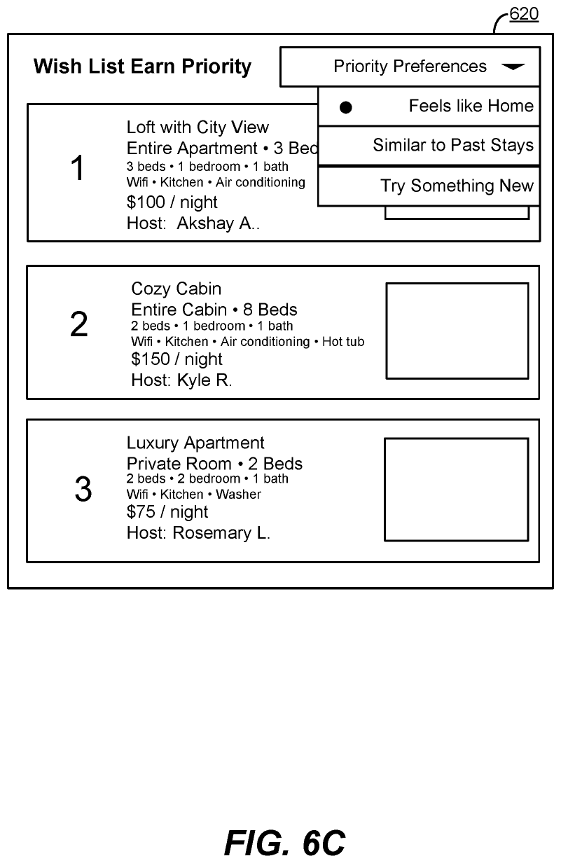

FIG. 6A illustrates one embodiment of a notification interface 600 on a client mobile device alerting a user of a hosting opportunity corresponding to an upcoming event. In particular, the interface 600 is a locked screen of the user's mobile computing device (e.g. host client device 110 or guest client device 120) which displays notifications recently received from an application installed on the device (application 125A or 125B) and any additional applications on the mobile computing device. In this case, the client device displays the notification on the notification interface 600 in response to a prompt recently received from the accommodation management system 130. The notification includes information included in the received prompt, for example alerting the user to an upcoming event and encouraging the user to host during the event. The user may respond to the notification by interacting with the mobile device, such as touching, swiping, or tapping the region of the mobile device screen displaying the notification.

FIG. 6B illustrates one embodiment of an interface 610 for displaying a prompt describing a hosting opportunity corresponding to an event. The accommodation management system 130 provides for display the interface 610 on a user's client device (e.g. the mobile device in FIG. 6A) based on a prompt provided by the prompt module 235. The interface 610 includes a description of the received event, a description of a listing on the user's wish list, and two virtual buttons. The prompt explains that if the user hosts an accommodation during the event, they may be able to earn the listing from the user's wish list 242 (i.e. the “luxury apartment”) identified by the event matching module 230. The accommodation management system 130 provides one or more additional interfaces for facilitating hosting an accommodation during the described event in response to a user interaction with the top button (i.e. the button labeled “accept to host). The accommodation management system 130 dismisses the prompt in interface 600 and ends the recommendation process in response to a user interaction with the bottom button (i.e. the button labeled “cancel”).

As depicted in FIG. 6B, in some embodiments the prompt module 235 includes the listing from the wish list 242 in the prompt presented to the user. In additional embodiments, the prompt includes a plurality of events and a plurality of wish list listings, wherein the user selects one or more events and one or more listings by interacting with the prompt.

In some embodiments, prompted users of the accommodation management system earn a stay (as suggested in the interface 610) on their wish list 242 by receiving monetary compensation based on the reservation criterion 253 of the hosted listing. In this case, the user may choose to use the monetary compensation earned from hosting to book the accommodation from the wish list 242 as recommended in the prompt. In other embodiments, the user automatically earns a stay at the accommodation from the wish list 242 upon successfully hosting a guest as recommended in the prompt. The user may then select dates to book the listing from the wish list 242 or the accommodation management system 130 may automatically book the listing for one or more particular dates (e.g. dates associated with the listing on the user's wish list 242).

If the event matching module 230 uses a generic listing in determining the estimated hosting value, the prompt may direct the user to create a listing on the accommodation management system 130. Following creation of the listing, the event matching module 230 may determine a new expected value with reference to the newly created listing. The prompt module 235 may then generate and display a second prompt to the user based on the re-determined expected value.

FIG. 6C illustrates one embodiment of an interface 620 for display a priority order of listings on a user's wish list as depicted in FIG. 3. The accommodation management system 130 provides for display the interface 620 on a user's client device (e.g. the mobile device in FIG. 6A) based on a prompt provided by the prompt module 235. The interface 620 includes three listings on a user's wish list 242 which are each assigned a priority ranking (i.e. 1, 2, and 3) by the online accommodations system 130. The online accommodations system 130 may use the priority ranking of a given listing on a user's wish list 242 in order to identify a listing from the user's wish list to include in the prompt generated by the prompt module 235. For example, the event matching module 230 may select a listing from the user's wish list with a higher priority ranking if more than one listing is matched with a given event. The interface 620 includes a drop-down menu which allows a user to select from several priority preferences. The priority preferences may be used by the accommodation management system 130 to determine the priority rankings of the listings on the wish list 242. For example, the priority preference “feels like home” is currently selected in FIG. 6C (as indicated by the black dot on the relevant label). As such, the accommodation management system 130 may rank the listings on the user's wish list 242 based on how similar the listings are to a listing corresponding to the user's home. Similarly, if the user selected “similar to past stays” the accommodation management system 130 may rank listings similar to listings the user has previously booked more highly. Finally, if the user selected “try something new,” the accommodation management system 130 may rank listings that are not similar to listings the user has previously booked more highly. Responsive to the user selecting a new priority preference, the accommodation management system 130 may re-determine the priority rankings and update the display of interface 620 to reflect the new priority rankings.

### Guest User Cancellations

In some embodiments, the prompt module 235 has access to booking cancellation data on the accommodation management system 130. The booking cancellation data may include any data relevant to a guest user's cancellation of a previously booked stay at an accommodation, such as the date the accommodation listing was booked, the date the booking was cancelled, an identifier of the guest user, an identifier of the accommodation listing, a reason provided by the guest user for the cancellation, etc. Accommodation management system 130 may store booking cancellation data in user objects 240 (e.g. cancellations the user has performed), in listing objects 250 (e.g. cancellations of the accommodation associated with the listing object), in additional data objects and/or data stores not depicted in FIGS. 2A and 2B, or any combination thereof.

In an embodiment, the prompt module 235 uses cancellation data to determine a recommended cancellation policy to include in a prompt sent to a host user. The term cancellation policy, as used herein, refers to a set of rules applied to a guest user and a host user when the guest user cancels a booking of the host user's accommodation listing. Cancellation policies may vary from flexible to strict. For example, a strict cancellation policy may enforce no refunds to the guest user when a booking is cancelled. As another example, a more flexible cancellation policy may allow refunds or partial refunds to the guest user if the booking is cancelled well enough in advance (e.g. 3 days prior to the booking date). When generating a prompt to a host user to host a listing during an event, the prompt module 235 may retrieve and process cancellation date corresponding to accommodation listings in the same geographic region of the event. In this case, the prompt module 235 may determine whether to recommend a more flexible or more strict cancellation policy based on how common cancellations are in the geographic region of the event. The prompt module 235 may also determine what cancellation policy to recommend based on additional factors such as how similar the accommodation listings corresponding to the cancellation data are to the host user's accommodation listing, how close to the booking date the cancellations occurred, the specific cancellation policies of the accommodation listings corresponding to the cancellation data, etc.

In an embodiment, the prompt module 235 considers environmental factors when determining what cancellation policy to recommend. For example, the prompt module 235 may retrieve weather data describing the weather forecast on the dates on or near the event (e.g. from a third-party weather service) and use the weather data to determine how likely cancellations will be during the event. For example, the weather data may indicate a high likelihood of torrential rain during the event, and as a result the prompt module 235 may recommend a flexible cancellation policy to account for inconvenience the bad weather may cause guest users. Similarly, if the weather data indicates sun and clear skies, the prompt module 235 may recommend a strict cancellation policy. In addition to weather data, the prompt module 235 may consider additional data describing environmental factors when determining a cancellation policy, such as the type of event (e.g. is it an event which often his high attendance attrition), how many accommodation listings in the geographic region are currently booked during the event, etc. The prompt module 235 may also periodically re-determine the recommended cancellation policy based on the environmental data and recommend an updated cancellation policy the host user if a new cancellation policy is determined.

In an embodiment, the prompt module 235 uses a machine learned model to determine a cancellation policy to recommend (i.e. a cancellation policy model). In this case, the prompt module 235 may encode some combination of the data described above (e.g. cancellation data, weather data, additional environmental data, etc.) in a feature vector and input the feature vector in to the cancellation policy model. The cancellation policy model then provides the cancellation policy as output, which the prompt module 235 includes in the recommendation to a host user. The prompt module 235 may allow a host user to adjust various parameters of the recommended cancellation policy in order to make the policy more flexible or stricter, based on host user preference. Furthermore, the prompt module 235 may train the cancellation policy model using feature vectors encoding historical data describing accommodation listing bookings on the accommodation management system 130 labeled with the actual policy applied to the booking by a host user and whether or not the booking guest user canceled. The prompt module 235 may then train the cancellation policy model to recommend a cancellation policy minimizing the likelihood of a cancellation. One skilled in the art will recognize that cancellation policy model could additionally be trained to achieve other goals, such as maximizing host user profit, guest user satisfaction as indicated in a rating of the accommodation listings, etc.

In some embodiments, the accommodation management system 130 may also use some combination of the data described above (e.g. cancellation data, weather data, additional environmental data, etc.) to provide a notification to guest users when booking accommodation listings. For example, if received weather data indicates bad weather on the date the guest user intends to book an accommodation listing, the accommodation management system 130 may notify the guest user of the forecasted weather and advise consideration of the weather when deciding whether to complete the booking. The notification may additionally include the current cancellation policy for the accommodation listing, the cancellation policies of other accommodation listings available in the same geographic region on the same dates, or some other information which may inform the guest user's decision to book the accommodation listing.

### Computing Machine Architecture

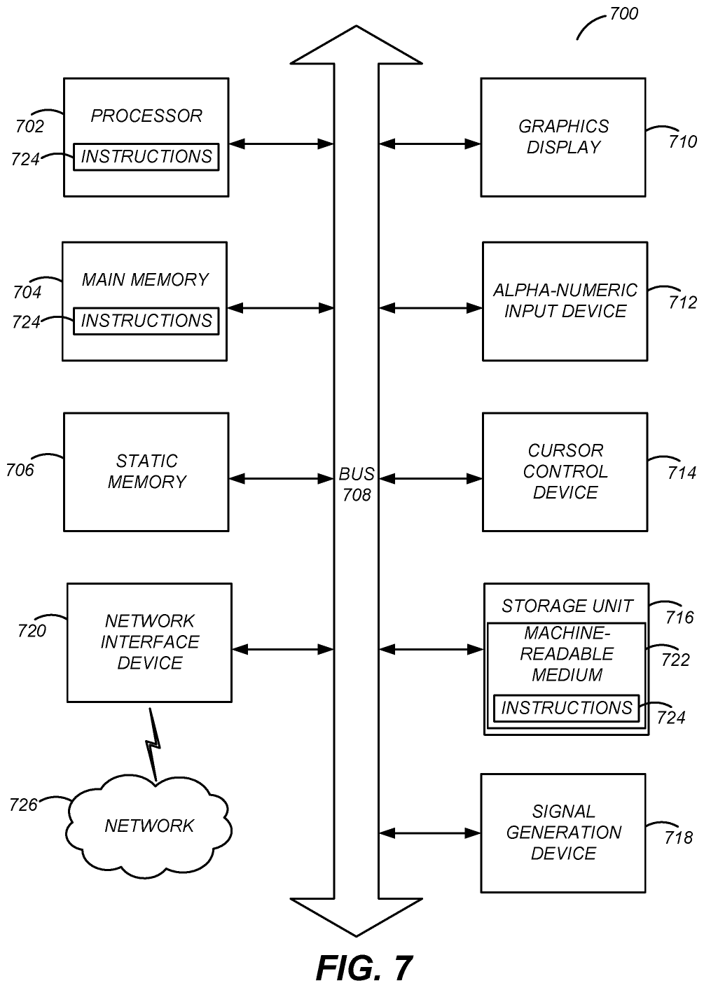

FIG. 7 is a block diagram illustrating components of an example machine able to read instructions from a machine-readable medium and execute them in a processor (or controller). Specifically, FIG. 700 shows a diagrammatic representation of a machine in the example form of a computer system 100 within which program code (e.g., software) for causing the machine to perform any one or more of the methodologies discussed herein may be executed. The program code may be comprised of instructions 724 executable by one or more processors 702. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processor 702 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include visual display interface 710. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 710 may include or may interface with a touch enabled screen. The computer system 700 may also include alphanumeric input device 712 (e.g., a keyboard or touch screen keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

### Prompting Users to Host During Events

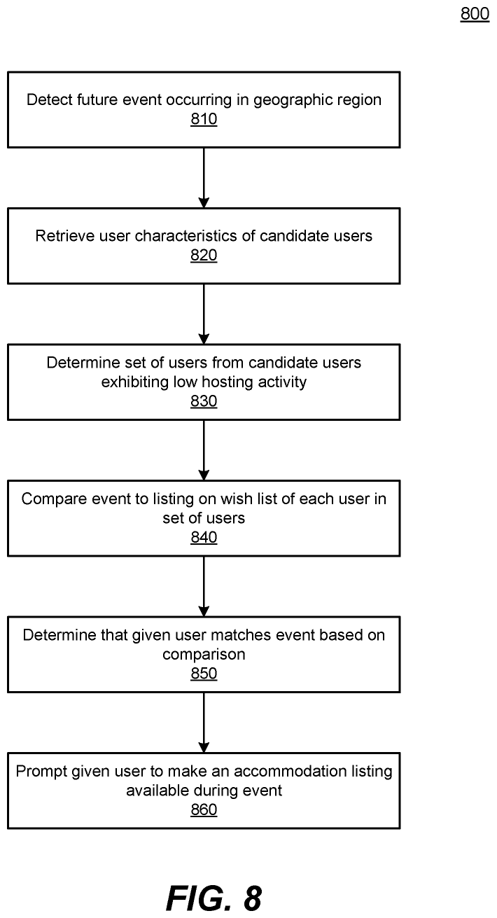

FIG. 8 illustrates one embodiment of a process for prompting users of the accommodation management system 130 exhibiting low hosting to make an accommodation listing available during a future event. Process 800 begins with the accommodation management system 130 detecting 810 a future event occurring on a future date in a geographic region. Responsive to detecting the even, the accommodation management system 130 retrieves 820 hosting data (e.g. from user store 205) of candidate users registered in the geographic region and are associated with an accommodation. Using the retrieved hosting data, the accommodation management system 130 determines 830 a set of users from the retrieved users exhibiting low hosting activity. For example, users who do not currently have an available listing during the event or have never made a listing available may be selected by the user activity module 225. For each user from the set of users, the accommodation management system 130 compares 840 the event to a plurality of accommodation listings on a wish list of the user. For example, an estimated hosting value for the event may be determined and then compared to reservation criteria of the accommodation listings on the wish list by the event matching module 230. Finally, in response to determining 850 that a given user matches the event (e.g. determining an accommodation listing on the user's wish list matching the event by the event matching module 230), the accommodation management system 130 prompts 860 the user to make an accommodation listing available during the event.

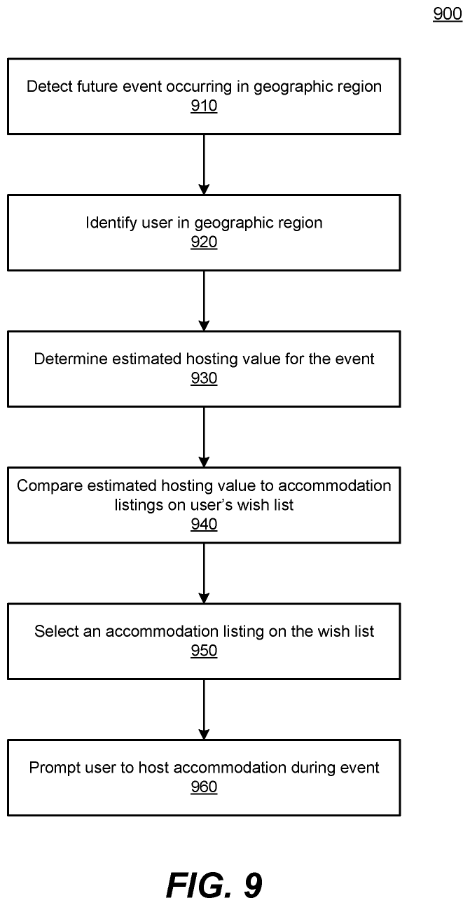

FIG. 9 illustrates one embodiment of a process for prompting a user of the accommodation management system 130 to host an accommodation during a future event. Process 900 begins with the accommodation management system 130 detecting 910 a future event occurring on a future date in a geographic region. Responsive to detecting the event, the accommodation management system 130 identifies 920 a user who registered on the system in the geographic region. For example, the user object 240 is matched with the future event object 260 by the event matching module 230. The online accommodation 130 then determines 930 an estimated hosting value to the user of hosting a guest during the event (e.g. using the event matching module 230). The accommodation management system compares 940 the estimated hosting value to a reservation criterion of one or more accommodation listings on the user's wish list. For example, the event matching module 230 may compare the reservation criterion of a plurality of accommodation listings on the user's wish list to the estimated hosting value for the event. Based on the comparison, the accommodation management system selects 950 an accommodation listing on the user's wish list with a reservation criterion satisfied by the estimated value. Finally, the accommodation management system 130 prompts 960 the user to host an accommodation during the event which specifies the selected accommodation listing (e.g. using the prompt module 235).

Other entities may perform some or all the steps of the process 800 and the process 900 in other embodiments. Likewise, embodiments may include different and/or additional steps, or perform the steps in different orders.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for prompting a user of an accommodation management system to host an accommodation during an event through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for identifying users of an accommodation management system to prompt to make accommodations listings available, the method comprising:
detecting, by the accommodation management system, an event occurring on a future date in a geographic region;
retrieving, from a data store, hosting data for each of a plurality of candidate host users of the accommodation management system, the hosting data indicating an accommodation in the geographic region associated with each user;
identifying, based on the hosting data, a set of users from the plurality of candidate host users that do not have an accommodation listing, on the accommodation management system, corresponding to the associated accommodation, that is available during the event; and
for each user of the set of users:
determining whether a characteristic of the event matches a characteristic of a listing on a wish list associated with the user; and
responsive to determining that the characteristic the event matches the characteristic of the listing on the wish list, outputting a prompt to the user to make an accommodation listing available for the associated accommodation during the future event.

2. The method of claim 1, wherein determining whether the characteristic of the event matches the characteristic of the listing on the wish list comprises:
determining an estimated hosting value from hosting the accommodation associated with the user during the event;
determining a reservation criterion for each of the plurality of accommodation listings on the wish list; and
identifying an accommodation listing on the wish list matching the estimated hosting value based on the accommodation listing's reservation criterion.

3. The method of claim 2, wherein the prompt specifies the identified accommodation listing from the wish list.

4. The method of claim 3, wherein the prompt is displayed using an interface which includes descriptions of the accommodation associated with the user, the identified accommodation listing from the wish list, and the event.

5. The method of claim 4, wherein the prompt specifies a second plurality of accommodation listings on the wish list each matching the estimated hosting value, the matching based on the reservation criteria of each of the second plurality of accommodation listings.

6. The method of claim 1, further comprising:
responsive to determining that the characteristic of the event does not match the characteristic of the listing on the wish list, refraining from outputting the prompt to the non-hosting user.

7. The method of claim 6, wherein the determining that the characteristic of the event does not match the characteristic of the listing on the wish list comprises:
determining an estimated hosting value to the user from hosting the accommodation associated with the user during the event;
determining a reservation criterion for each of the plurality of accommodation listings on the wish list; and
determining that none of the determined reservation criteria match the estimated hosting value.

8. The method of claim 1, wherein identifying the set of users further comprises:
for each host user in the plurality of candidate host users:
inputting the host data of the host user into a machine learned model; and
receiving a prediction that the host user will create the available listing for the accommodation associated with the host user during the event as output from the model.

9. The method of claim 8, further comprising:
retrieving, by the accommodation management system, hosting data for each of a second plurality of users of the accommodation management system, the hosting data of the second plurality of users indicating that each user of the second plurality of users frequently lists the accommodation associated with the user;
identifying, based on the hosting data of the second plurality of users, a second set of users from the second plurality of users, where each user of the second set of users has not made a previous accommodation listing available for the accommodation associated with the user during a plurality of events;
identifying, based on the second set of user characteristics, a third set of users from the second plurality of users, where each user of the third set of users has made a previous accommodation listing available for the accommodation associated with the user during the plurality of events;
labeling the hosting data of the second plurality of users based on the second set of users and the third set of users; and
training the model to predict whether the host user will create the available listing for the accommodation associated with the host user during the event based on the labeled hosting data of the second plurality of users.

10. The method of claim 1, wherein identifying the set of users further comprises:
for each host user of the plurality of candidate host users:
determining, based on the hosting data, a frequency of the host user previously making the accommodation listing available for the accommodation associated with the host user;
comparing the frequency to a hosting activity threshold; and
adding, based on the comparison, the host user to the set of users.

11. The method of claim 1, further comprising:
retrieving, by the accommodation management system, a second set of accommodation listings associated with each user of the set of users from a second accommodation management system;
determining a second set of users from the set of users, each user of the second set of users having an accommodation listing for the accommodation associated with the user on the second accommodation management system; and
removing each user in the second set of users from the set of users.

12. The method of claim 1, wherein identifying the event comprises:
retrieving, from a second data store, the reservation criteria associated with a date for each of a second plurality of accommodation listings corresponding to accommodations in the geographic region;
determining, based on the reservation criteria, an aggregated reservation criterion corresponding to the date;
comparing the aggregated reservation criterion to an event threshold; and
responsive to determining that the aggregated reservation criterion is above the event threshold, identifying the date as the event.

13. The method of claim 1, wherein identifying the event comprises:
retrieving, from a third-party system, data describing a plurality of topics relevant to the geographic region;
determining one or more future events mentioned in the plurality of topics; and
identifying, based on the data, the event from the one or more future events based on a number of mentions of the event in the data satisfying an event threshold.

14. The method of claim 1, wherein outputting the prompt comprises:
presenting, by the accommodation management system, the prompt to the user on an interface, the interface including the accommodation; and
receiving, responsive to an interaction by the user with the prompt, confirmation from the user to create the listing for the accommodation associated with the user.

15. The method of claim 1, wherein each accommodation listing from the wish list was added to the wish list by:
displaying, by the accommodation management system, an interface describing the accommodation listing including an interactable object for adding the accommodation listing to the wish list;
receiving an interaction with the interactable object from the user; and
adding, responsive to the interaction, the accommodation listing to the wish list.

16. The method of claim 1, wherein each accommodation listing from the wish list was added to the wish list by:
determining, based on the hosting data, a likelihood of the user booking the accommodation listing; and
adding, based on the likelihood exceeding a threshold, the accommodation listing to the wish list.

17. The method of claim 1, further comprising:
providing, responsive to the user hosting a guest user at the accommodation associated with the user during the event, a booking of the accommodation listing for the user.

18. A system for identifying users of an accommodation management system to prompt to make accommodation listings available, the system comprising one or more processors configured to execute instructions that cause the processor to:
detect, by the accommodation management system, an event occurring on a future date in a geographic region;
retrieve, from a data store, hosting data for each of a plurality of candidate host users of the accommodation management system, the hosting data indicating an accommodation in the geographic region associated with each user;
identify, based on the hosting data, a set of users from the plurality of candidate host users that do not have an accommodation listing, on the accommodation management system, corresponding to the associated accommodation, that is available during the event; and
for each user of the set of users:
determine whether a characteristic of the event matches a characteristic of a listing on a wish list associated with the user; and
responsive to determining that the characteristic the event matches the characteristic of the listing on the wish list, output a prompt to the user to make an accommodation listing available for the associated accommodation during the future event.

19. The system of claim 18, wherein determining whether the characteristic of the event matches the characteristic of the listing on the wish list comprises instructions that cause the processor to:
determine an estimated hosting value from hosting the accommodation associated with the user during the event;
determine a reservation criterion for each of the plurality of accommodation listings on the wish list; and
identify an accommodation listing on the wish list matching the estimated hosting value based on the accommodation listing's reservation criterion.

20. A computer readable medium configured to store instructions for identifying users of an accommodation management system to prompt to make accommodation listings available, the instructions when executed by a processor cause the processor to perform operations, the instructions comprising instructions to:
detect, by the accommodation management system, an event occurring on a future date in a geographic region;
retrieve, from a data store, hosting data for each of a plurality of candidate host users of the accommodation management system, the hosting data indicating an accommodation in the geographic region associated with each user;
identify, based on the hosting data, a set of users from the plurality of candidate host users that do not have an accommodation listing, on the accommodation management system, corresponding to the associated accommodation, that is available during the event; and
for each user of the set of users:
determine whether a characteristic of the event matches a characteristic of a listing on a wish list associated with the user; and
responsive to determining that the characteristic the event matches the characteristic of the listing on the wish list, output a prompt to the user to make an accommodation listing available for the associated accommodation during the future event.
